(19) United States
(12) Patent Application Publication
(10) Pub. No.: US 2017/0111377 A1
(43) Pub. Date: Apr. 20, 2017

(54) NETWORK CAPABLE OF DETECTING DoS ATTACKS AND METHOD OF CONTROLLING THE SAME, GATEWAY AND MANAGING SERVER INCLUDED IN THE NETWORK

(71) Applicant: Foundation of Soongsil University-Industry Cooperation, Seoul (KR)

(72) Inventors: Min Ho Park, Ansan (KR); Min Hoe Kim, Seoul (KR)

(73) Assignee: Foundation of Soongsil University-Industry Cooperation

(21) Appl. No.: 15/015,901

(22) Filed: Feb. 4, 2016

(30) Foreign Application Priority Data
Oct. 15, 2015 (KR) 10-2015-0143932

(51) Int. Cl. H04L 29/06

(52) U.S. Cl. CPC H04L 63/1416; H04L 63/1458

(57) ABSTRACT

A network capable of detecting a DoS attack and a method of controlling the same, a gateway and a managing server included in the network are disclosed. The network capable of detecting a DoS attack comprises gateways. Here, each of the gateways receives packets, generates a self organizing map SOM by learning the packets and detects using the SOM whether or not a packet to be received is a packet of the DoS attack.

### CROSS REFERENCE TO RELATED APPLICATIONS

This application claims priority to Korean Application No. 10-2015-0143932 filed on Oct. 15, 2015, which is incorporated herein by reference.

### TECHNICAL FIELD

The present disclosure relates to a network capable of detecting a DoS attack for preventing bottleneck when the DoS attack are detected and a method of controlling the same, a gateway and a managing server included in the network.

### BACKGROUND ART

Denial of Service DoS attack means a hacking technique for stopping operation of corresponding server by transmitting at a time much amount of access signals, which the sever can't process, to the server. It is possible to perform the DoS attack if a user uses an attack program distributed through Internet though the user does not have expert knowledge. The DoS attack is simple method, but attack route has been diversified and becomes intelligent more and more. Many studies about the DoS attack have been progressed and techniques for detecting effectively the DoS attack have been developed.

Data mining technique has been used as one of the techniques for detecting the DoS attack. The data mining technique means a technique for learning one by one features of packets (traffic) and detecting the DoS attack based on the learning, and it can detect new attack, categorize attacks, of which it is difficult to know pattern, according to features of the attacks and detect the attacks.

A self organizing map SOM of the data mining technique is shown in FIG. 1. The SOM generates a map separable features of packets by learning the packets inputted through a network, and classifies the packets into attack packet and normal packet using the generated map.

The SOM is shown with a low dimensional map irrespective of dimension of an input vector, and can perform in real time a learning process (SOM is automatically adaptive to change of statistical distribution of input data if the statistical distribution is changed according to time). Additionally, in the SOM, input data having similar pattern is gathered to a region near with one another from a node after training.

FIG. 2 is a view illustrating a network for detecting DoS attack using conventional SOM. A conventional network 200 includes a managing server 210 and gateways 220.

However, detection of the DoS attack using the conventional SOM has limitation. That is, if the DoS attack is performed to specific gateway in great network environment including the gateways 220, considerably many packets are gathered to the managing server 210 where the SOM operates, and thus bottleneck may occur. Occurrence possibility of the bottleneck increases according as size of the network managed by the managing server 210 augments.

### SUMMARY

To solve substantially obviate one or more problems due to limitations and disadvantages of the background art, one embodiment of the invention provides a network capable of preventing bottleneck when DoS attack is detected, a gateway and a managing server included in the same.

Other embodiments of the invention may be easily thought by a person in the art through below embodiments.

A network capable of detecting a DoS attack according to one embodiment of the invention includes gateways, wherein each of the gateways receives packets, generates a self organizing map SOM by learning the packets and detects using the SOM whether or not a packet to be received is a packet of the DoS attack.

The network further comprises a managing server configured to manage the gateways, wherein each of the gateways transmits the SOM to the managing server.

The managing server generates one integrated SOM using the SOMs of the gateways, transmits the integrated SOM to the gateways, and each of the gateways detects using the integrated SOM whether or not a packet to be received is a packet of the DoS attack.

The step of transmitting the SOM from each of the gateways and the step of generating and transmitting the integrated SOM by the managing server are repeatedly performed.

The managing server generates the integrated SOM using linear sum of the SOMs of the gateways.

The SOM is a two-dimensional map having m×n node, a vector for indicating feature of the packet is stored in the node of the two-dimensional map, and the managing server generates the integrated SOM through linear sum of vectors at the same position in the SOMs of the gateways.

The managing server generates the integrated SOM using following equation.

$${SOM}_{T} = {\sum }_{j} \frac{{amt}_{j}}{{Σ}_{i} {amt}_{i}} {SOM}_{j}$$

here, SOM_{T} means the integrated SOM, SOMⱼ indicates an SOM of jth gateway, and amtᵢ/amtⱼ means a number of packets received by ith/jth gateways, respectively.

A managing server for managing gateways in a network according to another embodiment of the invention includes a receiving unit configured to receive self organizing maps SOMs from the gateways; a map generating unit configured to generate one integrated SOM using the SOMs from the gateways; and a transmission unit configured to transmit the integrated SOM to each of the gateways, wherein each of the gateways detect using the integrated SOM whether or not a packet to be received is a packet of a DoS attack.

A gateway in a network according to still another embodiment of the invention includes a receiving unit configured to receive packets; a map generating unit configured to generate a self organizing maps SOM by learning the packets; a detection unit configured to detect whether or not a packet to be received is a packet of a DoS attack, using the SOM; and a transmission unit configured to transmit the SOM to a managing server, wherein the receiving unit receives an integrated SOM from the managing server, the detection unit detects using the integrated SOM whether or not a packet to be received is a packet of the DoS attack, and the integrated SOM is generated by the managing server by using linear sum of an SOM of at least one another gateway in the network and the SOM transmitted from the transmission unit.

A method of controlling a network capable of detecting a DoS attack with gateways and one managing server according to still another embodiment of the invention includes generating a self organizing maps SOM by learning packets through each of the gateways and transmitting the SOM from each of the gateways to the managing server; generating one integrated SOM using the SOMs of respective gateways through the managing server, and transmitting the integrated SOM from the managing server to each of the gateways; and detecting using the integrated SOM whether or not a packet to be received to the each of the gateways is a packet of a DoS attack, through each of the gateways.

In one embodiment of the invention, bottleneck may be prevented when DoS attack is detected.

### BRIEF DESCRIPTION OF DRAWINGS

FIG. 1 is a view illustrating concept of conventional SOM;

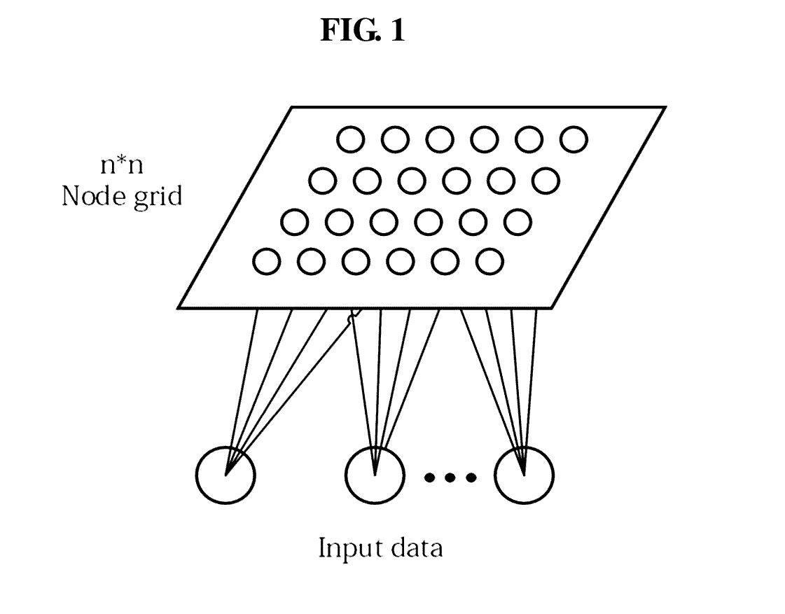

FIG. 2 is a view illustrating a network for detecting DoS attack using conventional SOM;

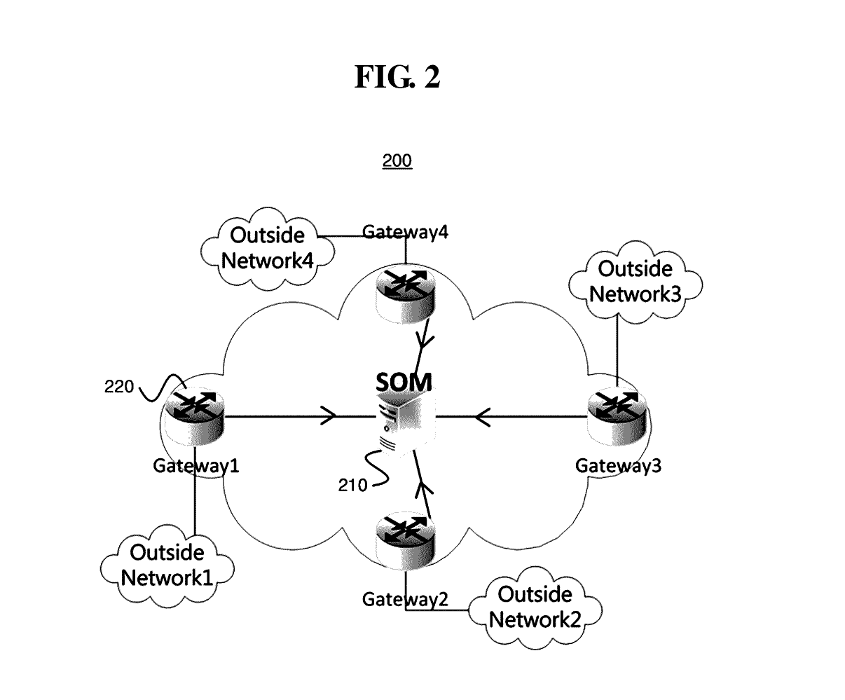

FIG. 3 is a view illustrating schematically a network for detecting DoS attack according to one embodiment of the invention;

FIG. 4 is a view illustrating schematically a managing server and a gateway according to one embodiment of the invention; and

FIG. 5 is a flowchart illustrating a process of controlling a network according to one embodiment of the invention.

### DETAILED DESCRIPTION

In the present specification, an expression used in the singular encompasses the expression of the plural, unless it has a clearly different meaning in the context. In the present specification, terms such as “comprising” or “including,” etc., should not be interpreted as meaning that all of the elements or operations are necessarily included. That is, some of the elements or operations may not be included, while other additional elements or operations may be further included. Also, terms such as “unit,” “module,” etc., as used in the present specification may refer to a part for processing at least one function or action and may be implemented as hardware, software, or a combination of hardware and software.

Hereinafter, embodiments of the invention will be described in detail with reference to accompanying drawings.

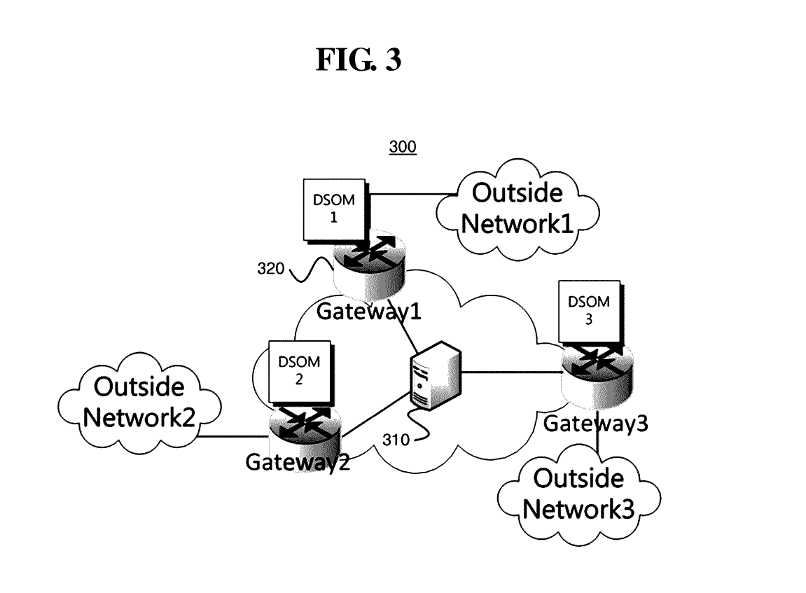

FIG. 3 is a view illustrating schematically a network for detecting DoS attack according to one embodiment of the invention.

In FIG. 3, a network 300 of the present embodiment includes a managing server 310 and gateways 320. Here, the gateways 320 may have the same structure.

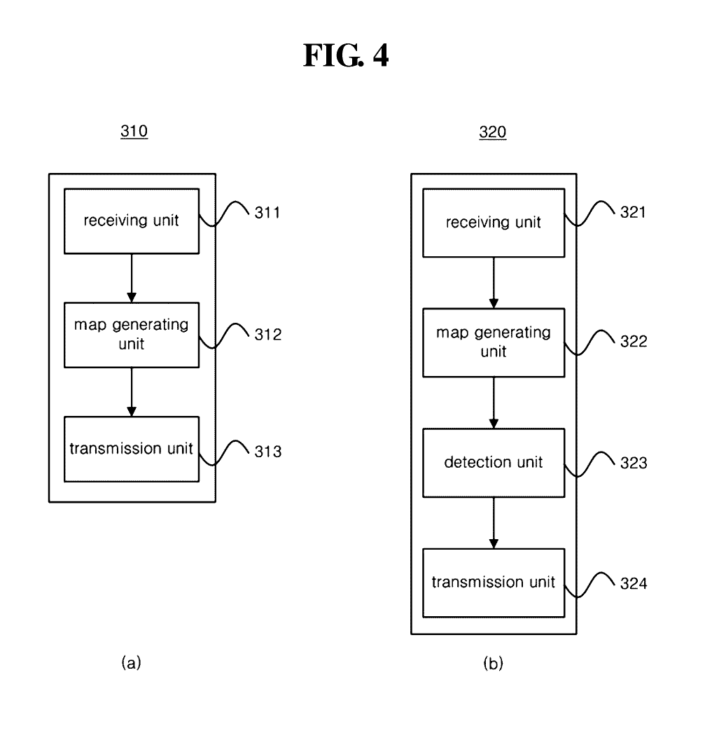

FIG. 4 is a view illustrating schematically a managing server and a gateway according to one embodiment of the invention.

Referring to (a) in FIG. 4, the managing server 310 includes a receiving unit 311, a map generating unit 312 and a transmission unit 313. Referring to (b) in FIG. 4, the gateway 320 includes a receiving unit 321, a map generating unit 322, a detection unit 323 and a transmission unit 324.

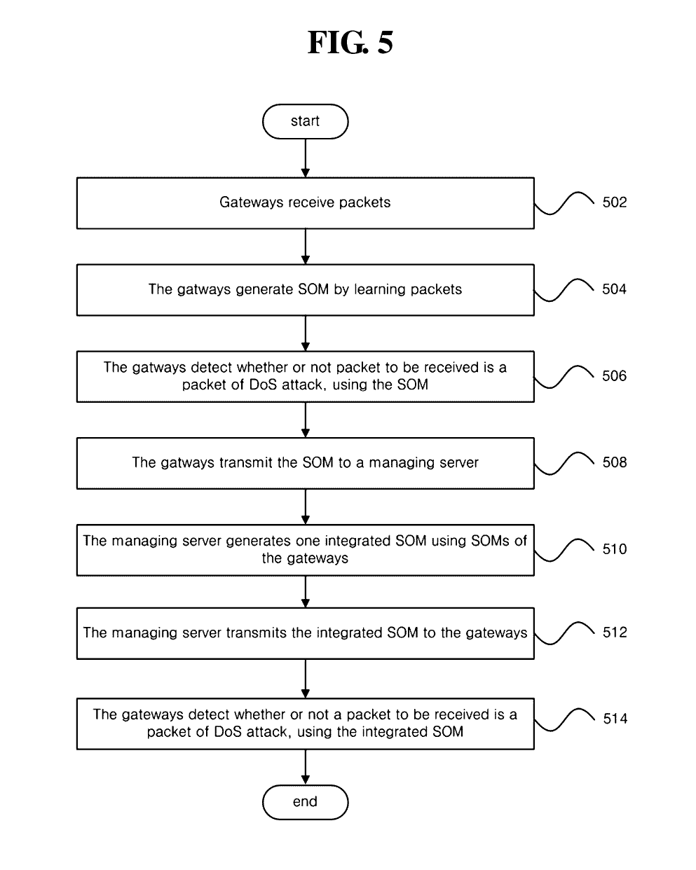

FIG. 5 is a flowchart illustrating a process of controlling a network according to one embodiment of the invention.

Hereinafter, embodiment of the invention will be described in detail with reference to accompanying drawings FIG. 3 to FIG. 5.

In a step of S502 (flow collector), the receiving units 321 of respective gateways 320 receive packets.

In a step of S504, each of the map generating units 322 of the gateways 320 generates a self organizing map SOM by learning the packets. That is, each of the gateways 320 extracts features of the packet needed for detection (feature extractor).

Here, the SOM may be two-dimensional map having nodes of m×n (e.g. map having size of 40×40), and a vector (hereinafter, referred to as “packet feature indicating vector”) indicating the feature of the packet may be stored in each of the nodes in the two-dimensional map.

The packet feature indicating vector may include six elements, wherein the six elements may be the number of flow, the number of the packet, the number of byte included in the packet, type of protocol for transmitting the packet, duration information and change number of a port. Here, the flow may include a source IP, a destination IP, a source port, a destination port and protocol type.

In the SOM, the packet feature indicating vectors may be stored or arranged in one of ascending order and descending order. Accordingly, packet feature indicating vectors having similar features may be arranged at similar position and be grouped.

In a step of S506, each of the detection units 323 of the gateways 320 classifies a packet to be received by using the generated SOM (classifier), and detects whether or not the packet is a packet of DoS attack.

Briefly, the network of the invention distributes the SOM to respective gateways 320 and the gateways 320 uses individually the SOM, thereby preventing to process information of every packet through one server (distribution SOM). Accordingly, bottleneck may be prevented.

In a step S508, each of the transmission units 324 of the gateways 320 transmits the SOM to the receiving unit 311 of the managing server 310 for managing the gateways 310.

In a step of S510, the map generating unit 312 of the managing server 310 generates one integrated SOM by using respective SOMs of the gateways 320. In a step of S512, the transmission unit 313 of the managing server 310 transmits the integrated SOM to each of the receiving units 321 of the gateways 320. In a step of S514, each of the detection units 323 of the gateways 320 detects whether or not a packet to be received is a packet of DoS attack, using the integrated SOM.

Here, the integrated SOM has the same size as each of the SOMs of the gateways 320, and is generated for detecting more accurately DoS attack.

For example, an SOM A learns a packet inputted into a gateway A, and an SOM B learns a packet inputted into a gateway B. However, since the SOM A and the SOM B learn different packet, the SOMs have different shape, and thus corresponding gateways generate different classifying result due to difference of the SOMs. Additionally, the gateways do not know packets attacking other gateway, and so detection probability about DoS attack which does not attack itself becomes lower.

Solve this problem, the network 300 of the invention shares partially or wholly the SOM generated by one gateway with the SOM generated by another gateway, and includes a process of integrating the vectors stored in the nodes of the SOMs for the purpose of increasing detection performance.

Accordingly, the map generating unit 312 of the managing server 310 generates the integrated SOM by using linear sum of the SOMs of the gateways 320.

Particularly, the map generating unit 312 of the managing server 310 may generate the integrated SOM using vector linear sum at the same position in the SOMs of the gateways 320. As described above, since the vectors are arranged in ascending order in respective SOM, vectors having similar feature are stored at the same position of respective SOM, and thus it is possible to apply the vector linear sum.

In one embodiment, the map generating unit 312 of the managing server 310 may generate the integrated SOM using linear sum reflecting a weight. That is, the map generating unit 312 of the managing server 310 may generate the integrated SOM using following equation 1.

$${SOM}_{T} = {\sum }_{j} \frac{{amt}_{j}}{{Σ}_{i} {amt}_{i}} {SOM}_{j} \qquad [ Equation 1 ]$$

Here, SOM_{T} means the integrated SOM, SOMⱼ indicates SOM of jth gateway, and amtᵢ/amtⱼ means the number of packets received by ith/jth gateways, respectively.

For example, in the event that 1000 packets are received to a gateway A, 2000 packets are received to a gateway B and 3000 packets are received to a gateway C for 60 seconds, linear sum equals to (SOM_{A}×(1/6)+SOM_{B}×(2/6)+SOM_{C}×(3/6)). That is, it is discriminated that the more the gateway receives the packets, the better corresponding SOM is generated through learning of the packets, and thus weight of the gateway receiving more the packets becomes higher.

On the other hand, the step S502 to the step S514 may be repeatedly performed, and so the integrated SOM has been continuously updated.

Table 1 shows comparing result of Dos attack detection performance of conventional network (centralized type) and the network 300 of the invention (distribution). Here, T, F, P and N mean True, False, Positive and Negative, respectively.

TABLE 1

| | TP | TN | FP | FN |
|---|---|---|---|---|
| Original | 95.7 | 96.77 | 4.3 | 3.23 |
| 1:1:1 | 99.19 | 94.44 | 0.81 | 5.56 |
| 1:2:3 | 100.0 | 92.86 | 0.0 | 7.14 |

Here, “Original” corresponds to the conventional network, and relative data shows detection performance result about attack packet after one server learns 9000 packets (traffic). “1:1:1” corresponds to the network 300 of the invention, and relative data shows detection performance result about 1000 packets according to linear sum after three gateways learn different 2000 packets. “1:2:3” corresponds to the network 300 of the invention, and relative data shows detection performance result after three gateways learn 1000 packets, 2000 packets and 3000 packets, respectively.

Referring to Table 1, it is verified that the network 300 of the invention may prevent network bottleneck and has excellent performance compared with the conventional network.

Also, the technical features described above can be implemented in the form of program instructions that may be performed using various computer means and can be recorded in a computer-readable medium. Such a computer-readable medium can include program instructions, data files, data structures, etc., alone or in combination. The program instructions recorded on the medium can be designed and configured specifically for the present invention or can be a type of medium known to and used by the skilled person in the field of computer software. Examples of a computer-readable medium may include magnetic media such as hard disks, floppy disks, magnetic tapes, etc., optical media such as CD-ROM's, DVD's, etc., magneto-optical media such as floptical disks, etc., and hardware devices such as ROM, RAM, flash memory, etc. Examples of the program of instructions may include not only machine language codes produced by a compiler but also high-level language codes that can be executed by a computer through the use of an interpreter, etc. The hardware mentioned above can be made to operate as one or more software modules that perform the actions of the embodiments of the invention, and vice versa.

The embodiments of the invention described above are disclosed only for illustrative purposes. A person having ordinary skill in the art would be able to make various modifications, alterations, and additions without departing from the spirit and scope of the invention, but it is to be appreciated that such modifications, alterations, and additions are encompassed by the scope of claims set forth below.

1. A network capable of detecting a DoS attack comprising:
gateways,
wherein each of the gateways receives packets, generates a self organizing map SOM by learning the packets and detects using the SOM whether or not a packet to be received is a packet of the DoS attack.

2. The network of claim 1, further comprising:
a managing server configured to manage the gateways,
wherein each of the gateways transmits the SOM to the managing server.

3. The network of claim 2, wherein the managing server generates one integrated SOM using the SOMs of the gateways, transmits the integrated SOM to the gateways, and
each of the gateways detects using the integrated SOM whether or not a packet to be received is a packet of the DoS attack.

4. The network of claim 3, wherein the step of transmitting the SOM from each of the gateways and the step of generating and transmitting the integrated SOM by the managing server are repeatedly performed.

5. The network of claim 3, wherein the managing server generates the integrated SOM using linear sum of the SOMs of the gateways.

6. The network of claim 5, wherein the SOM is a two-dimensional map having m×n node, a vector for indicating feature of the packet is stored in the node of the two-dimensional map, and
the managing server generates the integrated SOM through linear sum of vectors at the same position in the SOMs of the gateways.

7. The network of claim 6, wherein the managing server generates the integrated SOM using following equation.
$${SOM}_{T} = {\sum }_{j} \frac{{amt}_{j}}{{Σ}_{i} {amt}_{i}} {SOM}_{j}$$
here, SOM_{T} means the integrated SOM, SOMⱼ indicates an SOM of jth gateway, and amtᵢ/amtⱼ means a number of packets received by ith/jth gateways, respectively.

8. A managing server for managing gateways in a network comprising:
a receiving unit configured to receive self organizing maps SOMs from the gateways;
a map generating unit configured to generate one integrated SOM using the SOMs from the gateways; and
a transmission unit configured to transmit the integrated SOM to each of the gateways,
wherein each of the gateways detect using the integrated SOM whether or not a packet to be received is a packet of a DoS attack.

9. The managing server of claim 8, wherein the map generating unit generates the integrated SOM using linear sum of the SOMs of the gateways.

10. The managing server of claim 9, wherein the map generating unit generates the integrated SOM using following equation.
$${SOM}_{T} = {\sum }_{j} \frac{{amt}_{j}}{{Σ}_{i} {amt}_{i}} {SOM}_{j}$$
here, SOM_{T} means the integrated SOM, SOMⱼ indicates an SOM of jth gateway, and amtᵢ/amtⱼ means a number of packets received by ith/jth gateways, respectively.

11. A gateway in a network comprising:
a receiving unit configured to receive packets;
a map generating unit configured to generate a self organizing maps SOM by learning the packets;
a detection unit configured to detect whether or not a packet to be received is a packet of a DoS attack, using the SOM; and
a transmission unit configured to transmit the SOM to a managing server,
wherein the receiving unit receives an integrated SOM from the managing server, the detection unit detects using the integrated SOM whether or not a packet to be received is a packet of the DoS attack,
and the integrated SOM is generated by the managing server by using linear sum of an SOM of at least one another gateway in the network and the SOM transmitted from the transmission unit.

12. The gateway of claim 11, wherein the managing server generates the integrated SOM using following equation.
$${SOM}_{T} = {\sum }_{j} \frac{{amt}_{j}}{{Σ}_{i} {amt}_{i}} {SOM}_{j}$$
here, SOM_{T} means the integrated SOM, SOMⱼ indicates an SOM of jth gateway, and amtᵢ/amtⱼ means a number of packets received by ith/jth gateways, respectively.

13. A method of controlling a network capable of detecting a DoS attack with gateways and one managing server, the method comprising:
generating a self organizing maps SOM by learning packets through each of the gateways and transmitting the SOM from each of the gateways to the managing server;
generating one integrated SOM using the SOMs of respective gateways through the managing server, and transmitting the integrated SOM from the managing server to each of the gateways; and
detecting using the integrated SOM whether or not a packet to be received to the each of the gateways is a packet of a DoS attack, through each of the gateways.
